(19) United States
(12) Patent Application Publication
(10) Pub. No.: US 2011/0253501 A1
(43) Pub. Date: Oct. 20, 2011

(54) COIN MECHANISM FOR A BULK VENDING MACHINE

(75) Inventor: Richard K. Bolen, Champaign, IL (US)

(73) Assignee: The Northwestern Corporation, Morris, IL (US)

(21) Appl. No.: 13/086,808

(22) Filed: Apr. 14, 2011

Related U.S. Application Data
(60) Provisional application No. 61/324,010, filed on Apr. 14, 2010.

(51) Int. Cl. G07F 1/04; B23P 23/00

(52) U.S. Cl. 194/344; 29/401.1

(57) ABSTRACT

The present embodiments provide a coin receiving mechanism for a vending machine. In one embodiment, the coin receiving mechanism comprises a faceplate having at least one coin slot formed therein, a coin wheel, and a backplate dimensioned to cover at least a portion of the coin wheel and the faceplate. At least one attachment zone for coupling the backplate to the faceplate is positioned at least partially laterally outside of said opening formed in the vending machine. A method is also provided for retrofitting a vending machine by removing a first coin receiving mechanism having one coin slot from engagement with an opening formed in the vending machine, and installing a second coin receiving mechanism having two coin slots disposed in a side-by-side manner into engagement with the opening of the vending machine.

### PRIORITY CLAIM

This invention claims the benefit of priority of U.S. Provisional Application Ser. No. 61/324,010, entitled “Coin Mechanism for a Bulk Vending Machine,” filed Apr. 14, 2010, the disclosure of which is hereby incorporated by reference in its entirety.

### BACKGROUND

Bulk vending machines occupy a special and important position not just because of the sales generated therefrom but because of the unique niche that these machines possess in the minds of the public. The bulk vending machine has endured and thrived as a fixture of the retail environment. At least one bulk vending machine, and more likely several, can be found in the entrance way or lobby of many supermarkets, department stores, hardware stores, gas stations and restaurants in the United States. The proceeds of the bulk vending machine may augment the income of the proprietor of the premises where it is located or may be collected by an independent operator, which may be a charitable organization.

Coin operated bulk vending machines of the type used to vend candy, nuts, capsules containing articles, stickers, gum, and the like are commonplace. Conventional bulk vending machines comprise two primary operational segments, a product storage area, or hopper, and a base. The product storage area is typically disposed atop the base. The base contains a coin mechanism and at least one coin slot for receiving selected coinage. The base also includes a chute door through which the vended goods are dispensed to the consumer. While gravity provides the predominant force utilized in dispensing the product from bulk vending machines, mechanical force must be generated to move the product from the product storage area to the chute door. Typically, such actuating force is provided by a crank handle linked through selected gearing to a rotatable, segmented merchandise wheel located adjacent to, or within, the product storage area.

In operation, after the appropriate, authorized coinage is placed in the coin slot(s) of the coin mechanism, the manual crank handle is rotated one complete rotation by the consumer. As the crank handle is turned, it imparts an amount of incremental rotation, which is determined by the gearing, to the merchandise wheel disposed within the product storage area to cause the dispensation of at least one piece of the product to the chute door. Bulk vending machines require no electrical assistance in order to dispense a product to the consumer.

There are numerous popular bulk vending machines currently in the retail environment that comprise a coin mechanism for receiving a single coin, such as a penny or a quarter. One of the most popular selling bulk vending machines is the model M60® machine, made by the Northwestern Corporation of Morris, Ill. However, due to inflation over the years, sometimes a product intended to be sold in the vending machine may require greater than a single coin. For example, it may be desirable to now sell products that used to be sold for 25 cents (a single quarter) for 50 cents (two quarters). Accordingly, in this example, a coin mechanism for accommodating 50 cents (two quarters) must be provided to the user.

A coin mechanism is known for accepting two coins that requires a user to position the two coins such that a first coin is directly in front of a second coin. However, the inventor has discovered that many users, especially children, have a difficult time knowing how to properly insert the two required coins one in front of the other. Thus, potential sales are lost.

Moreover, coin mechanisms for accepting two coins generally are larger than coin mechanisms for accepting a single coin, and therefore a partially or entirely new bulk vending machine is required to accommodate the coin mechanisms for accepting two coins. In particular, a larger opening may be needed in the base of the vending machine, or an entirely new base or vending machine altogether, for housing a coin mechanism that requires first and second coins.

Given that numerous bulk vending machines for receiving a single coin are on the market, it would be desirable to provide a retrofit for existing bulk vending machines to replace an existing coin mechanism that requires a single coin with a new coin mechanism that requires first and second coins, without replacing base units or the entire machine.

### SUMMARY

The present embodiments provide a coin receiving mechanism for a vending machine. In one embodiment, the coin receiving mechanism comprises a faceplate having at least one coin slot formed therein, a coin wheel, and a backplate dimensioned to cover at least a portion of the coin wheel and the faceplate. At least one attachment zone for coupling the backplate to the faceplate is positioned at least partially laterally outside of said opening formed in the vending machine.

A method is also provided for retrofitting a vending machine by removing a first coin receiving mechanism having one coin slot from engagement with an opening formed in the vending machine, and installing a second coin receiving mechanism having two coin slots disposed in a side-by-side manner into engagement with the opening of the vending machine.

Advantageously, a retrofit for existing bulk vending machines is provided to replace an existing coin mechanism that requires a single coin with a new coin mechanism that requires first and second coins, without increasing the dimensions of the opening in the vending machine. In particular, by providing at least one of the attachment zones between the faceplate and the backplate at least partially laterally outside of the opening, the coin mechanism for accommodating first and second coins may fit within the same opening that typically houses a coin mechanism that receives only a first coin.

A coin wheel for use in a vending machine also is disclosed. In one example, the coin wheel comprises front and rear surfaces, wherein the front surface has a frontward raised hub, and wherein the coin wheel has at least one coin pocket for receiving a coin.

Advantageously, by providing a raised hub of the coin wheel extending in a frontward direction, i.e., towards the user, additional space may be provided on the rear surface of the coin wheel, e.g., for accommodating two different coins received in first and second coin pockets. Moreover, the additional space provided on the rear surface of the coin wheel allows unauthorized slugs to fall through a space between the coin wheel and backplate with relatively low impedance for collection. Therefore, multiple significant advantages are achieved by providing the raised hub of the coin wheel in a frontward direction, as opposed to a rearward direction.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a bulk vending machine employing a previously known coin mechanism.

FIG. 2 is an exploded view showing features of the coin mechanism of FIG. 1.

FIG. 3 is a perspective view of the bulk vending machine of FIG. 1 with the coin mechanism removed.

FIG. 4 is a perspective view of the bulk vending machine of FIG. 1 with a retrofitted coin mechanism provided in accordance with the present embodiments.

FIG. 5 is front view of the coin mechanism of FIG. 4.

FIG. 6 is a rear perspective view of a faceplate of the coin mechanism of FIG. 4.

FIG. 7 is a front perspective view of a coin wheel of the coin mechanism of FIG. 4.

FIG. 8 is a rear perspective view of the coin wheel of FIG. 7.

FIG. 9 is a rear view illustrating the coin wheel of FIG. 7 in engagement with the faceplate of FIG. 6.

FIG. 10 is a rear view illustrating a backplate of the coin mechanism of FIG. 4.

FIG. 11 is a rear view depicting an assembled faceplate, coin wheel and backplate in accordance with the present embodiments.

FIG. 12 is a front view of the coin wheel of the coin mechanism of FIG. 4.

FIG. 13 is a rear view of the coin wheel of the coin mechanism of FIG. 4.

FIG. 14 is a rear perspective view illustrating the backplate of the coin mechanism of FIG. 4.

FIG. 15 is a front perspective view illustrating the backplate of the coin mechanism of FIG. 4.

FIG. 16 is a rear perspective view depicting an assembled faceplate, coin wheel and backplate in accordance with the present embodiments.

FIG. 17 is another rear perspective view depicting an assembled faceplate, coin wheel and backplate in accordance with the present embodiments.

FIG. 18 is a perspective view of a pawl that may be used in the coin mechanism of FIG. 4.

FIG. 19 is a perspective view of a ratchet that may be used in the coin mechanism of FIG. 4.

FIG. 20 is a perspective view of a return pawl that may be used in the coin mechanism of FIG. 4.

### DETAILED DESCRIPTION OF THE PREFERRED EMBODIMENTS

In the embodiments of FIGS. 4-11, a retrofit for existing bulk vending machines is provided, which can replace an existing coin mechanism that requires a single coin with a new coin mechanism that requires first and second coins in a side-by-side manner, without increasing the dimensions of the opening in a base unit of the vending machine.

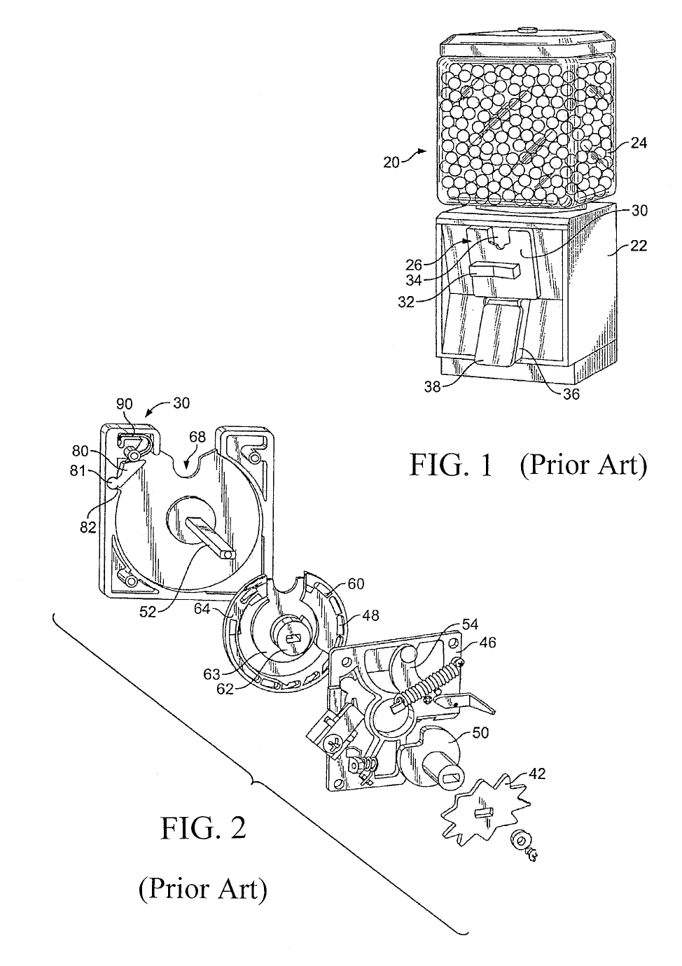

Referring to FIG. 1, there is shown a known bulk vending machine 20 that accommodates a single coin. In one embodiment, the bulk vending machine 20 is a standard model M60® bulk vending machine made by the Northwestern Corp. of Morris, Ill. The bulk vending machine 20 includes a base unit 22 and a product holder 24. The base unit 22 may be a generally rectangular metal housing. The product holder 24 may be made of a molded high strength clear plastic. The present embodiment may be incorporated in bulk vending machines other than the M60®, such as the Triple Play®, also made by the Northwestern Corp., or it may be incorporated in other bulk vending machines. The bulk vending machine 20 may be mounted on, or include, a stand (not shown), typically having a heavy base portion and a post extending from the base portion to engage the base unit 22.

The bulk vending machine 20 includes a coin receiving and processing mechanism 26, which is mounted in the base unit 22. The mechanism 26 includes a faceplate 30 and a handle 32. When a coin of the proper denomination is deposited into a receptacle or slot 34 and the handle 32 is turned (here, counterclockwise) the coin mechanism 26 and dispensing mechanism (not shown) dispense a product, such as a gumball, down a chute 36 to a door 38.

The coin receiving and processing mechanism 26 is generally shown in FIG. 2, and can be like that disclosed and claimed in Northwestern Corporation's U.S. Pat. Nos. 5,339,937 (hereinafter 'the 937 patent), 6,079,540 (hereinafter 'the 540 patent), and 7,513,353 (hereinafter 'the 353 patent), each of which are hereby incorporated by reference in their entirety. The faceplate 30 mounts to a backplate 46. Behind the backplate plate 46, a cam 50 and gear 42 are rotatably operated by a stem 52 affixed to the handle 32. A cam return lever 54 abuts the cam 50. Working together, the cam 50 and return lever 54 rotate the stem 52 so as to return the handle 32 to its starting position after it has been turned and a product has been dispensed, as more particularly disclosed in the '937 and '540 patents.

The stem 52 also turns a coin wheel 60. The coin wheel 60 comprises a stem-accepting hub 62, an intermediate web 63, and a peripheral raised rim 64. Slots 48 are formed in the rim 64 to be engaged by a finger (not shown) so as to prohibit wheel rotation in an improper direction.

Interrupting the rim 64 is a coin pocket shaped and adapted to snugly receive a coin of predetermined size and denomination, such as a U.S. quarter. The coin pocket is located on the wheel rim 64 so as to mate with a similar recess 68 formed in the faceplate 30, as explained further in 'the 353 patent.

Cooperating with the coin wheel 60 to prevent the introduction of anything other than required coins is a pawl 80. As used herein, the term “required” refers to a genuine and properly sized coin, as opposed to unauthorized slugs or genuine coins of improper denomination. As shown in FIG. 2, the pawl 80 is mounted on the faceplate 30 by a journal formation 81 adapted to be received in a mating recess 82 in the faceplate 30. The pawl 80 is biased into engagement with the outer periphery of the coin wheel 60 by a biasing spring 90, which may include two nested elements for added resiliency and force, if desired. As explained in more detail in the '353 patent, the pawl 80 rides over the wheel rim periphery as the coin wheel 60 turns, and the pawl 80 is depressed downwardly and to the right by the action of this spring 90. As explained in the '353 patent, with no coin present, the pawl 80 remains in its depressed downwardly position and strikes a corner of the rim periphery, stopping further rotation of coin wheel 60. However, in the instance a properly sized coin is present, the coin wheel 60 is rotated and the coin advances such that pawl 80 clears and does not engage the rim 64, as explained further in the '353 patent. The coin wheel 60 then can be turned through a sufficient rotational displacement to operate the product dispensing assembly (not shown) and deliver the product to the chute 36 and dispensing door 38.

If, however, the coin is too large, the coin strikes a part of the faceplate 30 and further wheel 60 rotation is prohibited. If the coin is too small, the pawl 80 slides over the coin so as to engage the opposite corner of the rim 64, and therefore, the pawl 80 then prohibits further wheel 60 rotation, as explained further in the '353 patent.

The bulk vending machine 20 of FIGS. 1-2 is very popular with retailers and comprises excellent functionality. However, the bulk vending machine 20 comprises one coin slot 34 which, for example, may accommodate a United States quarter dollar. If a retailer wishes to charge a different amount for merchandise within the bulk vending machine that requires two coins, such as fifty cents (two quarters), the retailer may need to purchase a new machine that has built therein an opening for a newly-sized coin mechanism.

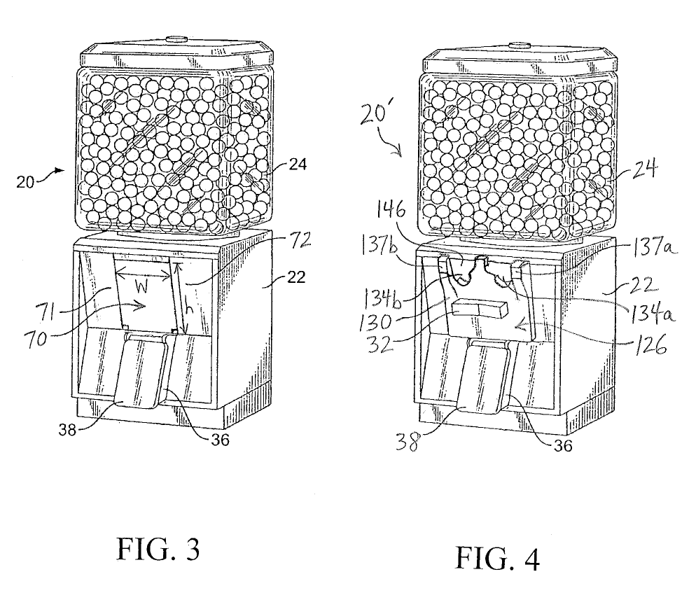

Referring to FIG. 3, if it becomes desirable to replace the coin mechanism 26 of FIGS. 1-2, the coin mechanism 26 may be removed from the bulk vending machine 20, leaving an opening 70 formed in the base unit 22 above the chute door 38. The opening 70 generally comprises a width w and a height h. First and second regions 71 and 72 of the base unit 22 are positioned laterally adjacent to the opening 70, as shown in FIG. 3. It should be noted that when the coin mechanism 26 of FIG. 1 was in use, the faceplate 30 slightly overlapped with the first and second regions 71 and 72 of the base unit 22. Further, the backplate 46 was dimensioned to fit snugly through the opening 70 during use.

Referring now to FIG. 4, a first embodiment of a side-by-side coin mechanism 126 provided in accordance with the present embodiments is shown. In accordance with one aspect of the present embodiments, the side-by-side coin mechanism 126 may be used as a retrofit into an existing bulk vending machine, such as a the bulk vending machine shown in FIGS. 1-2 which requires only a single coin. For example, if it becomes desirable to replace the coin mechanism 26 of FIGS. 1-2, which can only accommodate a single coin, with the side-by-side coin mechanism 126 of FIGS. 4-11, then an owner of the bulk vending machine may exchange the different coin mechanisms 26 and 126. When installed, a modified, retrofitted bulk vending machine 20′ is obtained, as shown in FIG. 4.

The side-by-side coin mechanism 126 comprises a faceplate 130, as shown in FIG. 4, and further comprises a coin wheel 160 and a backplate 146, each of which are shown and described further below. First and second slots 134a and 134b formed in the faceplate 130. When two coin of the proper denomination are deposited into first and second slots 134a and 134b and a handle 132 is turned, the coin mechanism 126 and dispensing mechanism (not shown) dispense a product, such as a gumball, down the chute 36 to the door 38, as generally described above in FIGS. 1-2.

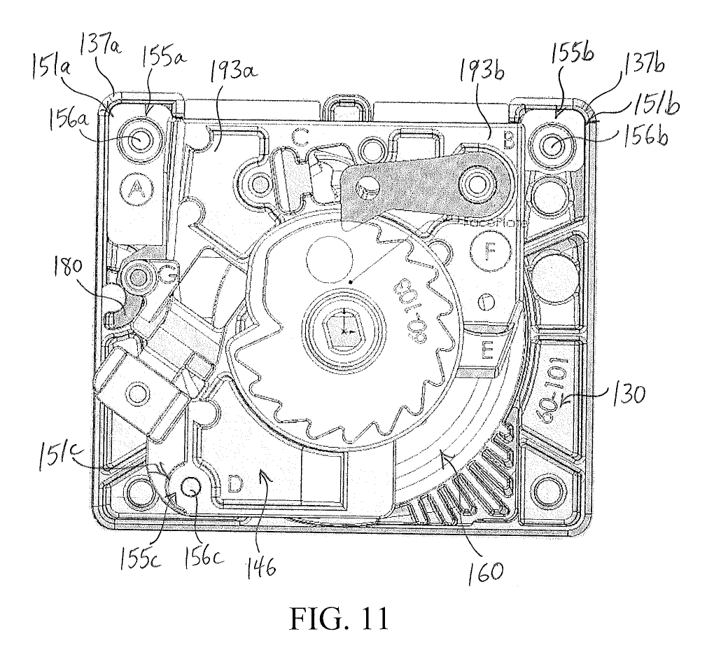

One or more attachment zones are provided for coupling the faceplate 130 to the backplate 146. In the embodiment of FIGS. 4-11, at least one of the attachment zones is positioned at least partially outside of the opening 70 of the bulk vending machine 20′. For example, attachment zones 151a and 151b (see FIG. 6 and FIG. 11) may be formed within frontward raised portions 137a and 137b of the faceplate 130. As depicted in FIG. 4, the frontward raised portions 137a and 137b of the faceplate 130 are positioned to generally overlap the first and second regions 71 and 72 of the base unit 22, i.e., at locations at least partially laterally adjacent to the opening 70. Accordingly, such attachment zones are positioned at least partially laterally outside of the opening 70 of the bulk vending machine, as explained further below.

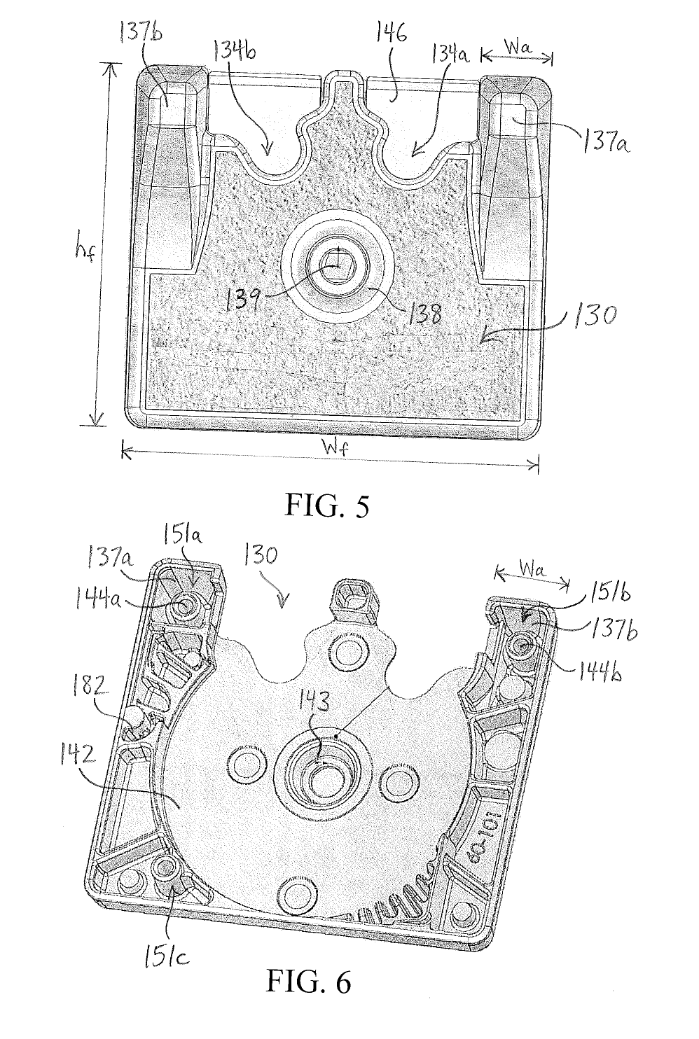

Referring now to FIGS. 5-6, further features of the faceplate 130 are shown. The faceplate 130 comprises a frontward extending segment 138 and an opening 139 formed therein. As used herein, the term “frontward” generally defines a direction towards a user of the vending machine, while the term “rearward” generally defines a direction away from a user.

A handle, such as the handle 32 having the handle stem 52 shown in FIGS. 1-2, may be used in conjunction with the side-by-side coin mechanism 126 of FIG. 4. The handle 32 may be coupled to the faceplate 130 such that the handle stem 52 extends rearward through the opening 139. In use, the handle 32 is positioned in front of the raised segment 138 for actuation by a user, as depicted in FIG. 4.

The faceplate 130 further comprises a width w_{f} and a height h_{f}, as depicted in FIG. 5. The height h_{f} may be approximately the same height as a corresponding height of the faceplate 30 of the coin mechanism 26 of FIGS. 1-2 above. The width w_{f} is greater than a corresponding width of the faceplate 30 of the coin mechanism 26. Notably, the attachment zones 151a and 151b, generally within the frontward raised portions 137a and 137b of the faceplate 130, respectively, comprise widths wₐ. Preferably, the widths wₐ overlap with the first and second regions 71 and 72 of the base unit 22, more than they overlap with the opening 70. Accordingly, during use, the attachment zones 151a and 151b are predominately located outside of the dimensions of the opening 70.

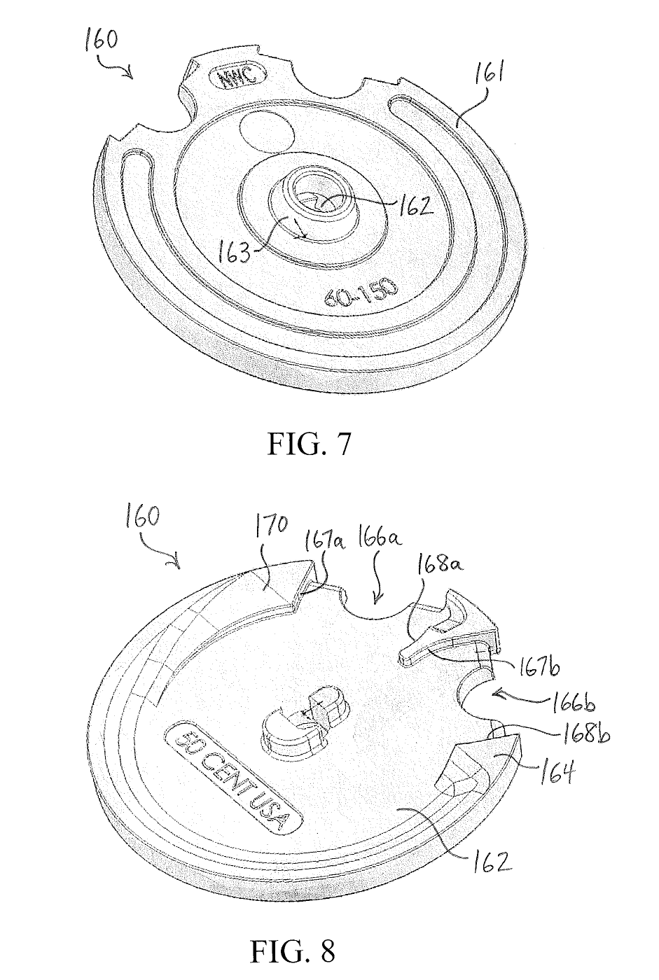

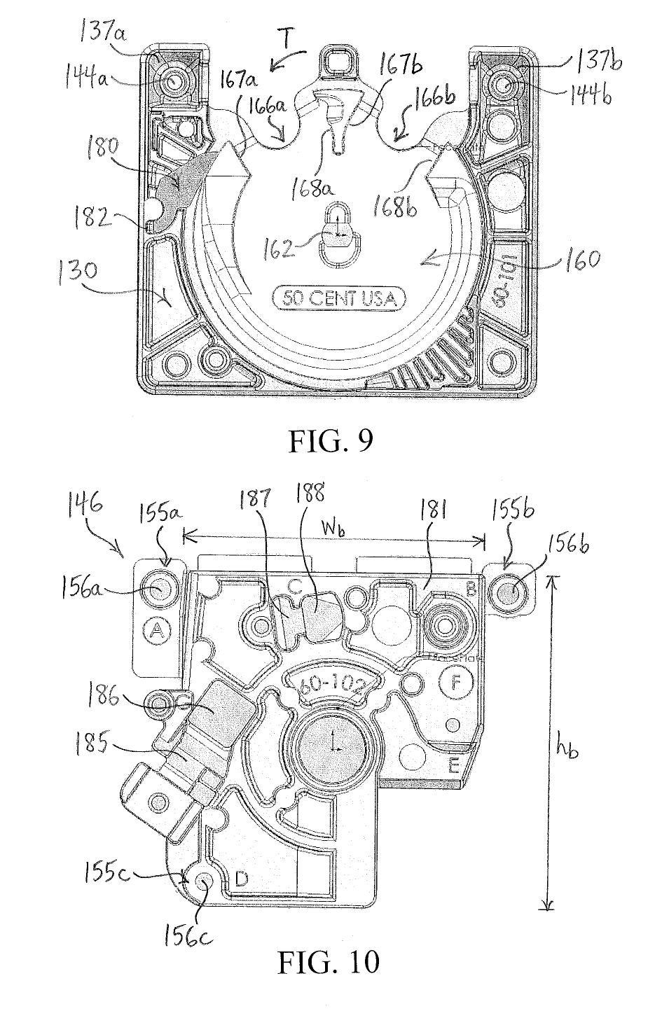

When seen from the rear view of FIG. 6, it can be seen that the faceplate 130 comprises various recessed portions. In particular, a main recess 142 of the faceplace 130 is sized and configured to receive the coin wheel 160 shown in FIGS. 7-8 and described further below. A portion of the main recess 142 transitions into a central recess 143, which is the rear portion of the frontward extending segment 138 shown in FIG. 5. The rear surface of the faceplate 130 further comprises a recess 182 that is configured to receive a pawl 180, as shown in FIG. 9 and described further below. Functionality of the pawl 180 is generally similar to the functionality of the pawl 80 shown in FIG. 2 and described further in the '353 patent.

As shown in FIG. 6, the frontward raised portions 137a and 137b of the faceplate 130 are dimensioned to accommodate a mechanical attachment member for coupling the faceplate 130 to the backplate 146. In one embodiment, the mechanical attachment member comprises a screw that is adapted to be screwed into holes 144a and 144b in the frontward raised portions 137a and 137b of the faceplate 130, respectively. In alternative embodiments, however, the mechanical attachment member may comprise a solder, spot weld, or other mechanical device such as a clip. Attachment of the faceplate 130 to the backplate 146 is shown in FIG. 11 and described further below.

Referring now to FIGS. 7-8, further features of a coin wheel 160 for use in the side-by-side coin mechanism 126 are shown. The stem 52 of the handle 32 extends through a stem opening 162 in the coin wheel to therefore turn the coin wheel 160. The stem opening 162 may be disposed within a frontward raised hub 163 of the coin wheel 160, as shown in FIG. 7. The frontward raised hub 163 is sized to mate with the central recess 143 formed in the rear surface of the faceplate 130, as depicted in an assembled state of FIG. 9. Notably, the hub 163 of the coin wheel 160 is oriented in a frontward direction, i.e., towards the user. By contrast, the stem-accepting hub 62 and web 63 of the prior coin wheel 60 of FIGS. 1-2 are oriented in a rearward direction, i.e., away from the user.

Advantageously, by providing the frontward raised hub 163 of the coin wheel 160 in a frontward direction, i.e., towards the user, additional space may be provided on the rear surface 162 of the coin wheel 160, e.g., for accommodating two different coins received in first and second coin pockets 166a and 166b. Moreover, the additional space provided on the rear surface 162 of the coin wheel 160 allows unauthorized slugs to fall through a space between the coin wheel 160 and backplate 146 for collection. Therefore, multiple significant advantages are achieved by providing the frontward raised hub 163 of the coin wheel 160 in a frontward direction, as opposed to a rearward direction.

The rear surface 162 of the coin wheel 160 further comprises a peripheral raised rim 164, which is interrupted by first and second coin pockets 166a and 166b, as shown in FIG. 8. The first coin pocket 166a has a leading edge 167a and a trailing edge 168a, while the second coin pocket 166b has a leading edge 167b and a trailing edge 168b, as shown in FIGS. 8-9. The first and second coin pocket 166a and 166b are shaped and adapted to snugly receive a coin of predetermined size and denomination, such as a U.S. quarter. The coin pockets 166a and 166b are located on the wheel rim 64 so as to mate with a similar recess 68 formed in the faceplate 130. The wheel rim 164 is also partially interrupted, in an axial direction, to define a notch 170 sized and shaped to accommodate the presence of a first pawl 180, as shown in FIG. 9, and explained further in the '353 patent.

Referring to FIG. 9, engagement of the faceplate 130 and the coin wheel 160 is shown. The coin wheel 160 is turned in an operating direction as suggested by the arrow T in FIG. 9. The first pawl 180 cooperates with the coin wheel 160 to prevent the introduction of unauthorized slugs or genuine coins of improper denomination. As explained above, and further in the '353 patent, the first pawl 180 is biased into engagement with the outer periphery of the coin wheel 160 by a biasing spring, and as the coin slot is presented to the bottom of the pawl 180, the pawl 180 is depressed downwardly and to the right by the action of this spring. As explained further in the '353 patent, with no coin present, or an undersized coin, the pawl 180 will fall into engagement with a portion of the coin pocket 166a and prevent further rotation of the coin wheel 160.

Unlike the embodiment of the '353 patent, the side-by-side coin mechanism 126 of the embodiment of FIGS. 4-11 herein accommodates two coins. Therefore, at least two different pawls may be used to assure that two genuine coins are present. For example, if a genuine coin is placed only in the second coin slot 166b, but the first coin slot 166a is empty, then upon rotation of the coin wheel 160 the first pawl 180 will become depressed into engagement with the trailing edge 168a of the first coin slot 166a, thereby preventing further rotation of the coin wheel 160. Alternatively or in lieu of the first pawl 180, another pawl (not shown) may be positioned within a recess 185 in the backplate 146, and be biased frontward through an opening 186 of the backplate to engage the first coin slot 166a to prevent rotation if a proper coin is not present in the first coin slot 166a.

Similarly, a second pawl (not shown) may be positioned within a recess 187 in the backplate 146, and be biased frontward through an opening 188 of the backplate to engage the trailing edge 168b of the second coin slot 166b to prevent rotation of the coin wheel 160 if a proper coin is not present in the second coin slot 166b.

However, if proper size coins are present in both the first and second coin slots 166a and 166b, then the pawls slide over the coins, and are not depressed into engagement with either trailing edges 168a or 168b. The coin wheel 160 therefore completes its rotation and dispenses a product, as generally described above.

Referring now to FIGS. 10-11, further features of the backplate 146, and its engagement with the faceplate 130 and the coin wheel 160, are shown and described. In FIG. 10, it can be seen that the backplate 146 comprises a primary width w_{b} and a primary height h_{b}. The primary width w_{b} and the primary height h_{b} may be approximately the same dimensions as corresponding width and height dimensions of the backplate 46 of the coin mechanism 26 of FIGS. 1-2 above. Accordingly, both the backplate 46 of the coin mechanism 26 and the backplate 146 of the coin mechanism 126 may be disposed within and engage the opening 70 of the same bulk vending machine 20 shown above.

While the backplate 146 is generally dimensioned to fit within the opening 70 formed in the machine 20, the backplate 146 may comprise at least one attachment segment, which couples the faceplate 130 to the backplate 146, that is positioned predominately outside of the perimeter of the opening 70 and frontward of the opening 70. For example, in the embodiment of FIGS. 10-11, the backplate 146 comprises three attachment segments 155a-155c, optionally each having bore 156a-156c formed therein for receiving a mechanical attachment member. The bores 156a-156c of the three attachment segments 155a-155c of the backplate 146 are positioned to line up with the holes 144a-144c of the faceplate 130, thereby allowing three mechanical members to couple the faceplate 130 to the backplate 146 at these three locations. The attachment of the faceplate 130 to the backplate 146 therefore occurs within the attachment zones 151a-151c shown in FIG. 6.

Notably, two of the attachment segments 155a and 155b are positioned frontward relative to a main body 181 of the backplate 146. In use, the main body 181 is positioned primarily inside of the opening 70 of the vending machine. However, the attachment segments 155a and 155b of the backplate are positioned within the frontward raised segments 137a and 137b of the faceplate 130, respectively, as shown in the assembled state of FIG. 11. Therefore, at these two attachment zones 151a and 151b, the attachment between the frontplate 130 and the backplate 146 therefore occurs frontward relative to the opening 70 and at least partially outside of the perimeter of the opening 70.

Advantageously, a retrofit for existing bulk vending machines is provided that can replace an existing coin mechanism that requires a single coin with a new coin mechanism that requires first and second coins, without increasing the dimensions of the opening 70. In particular, by providing at least one of the attachment zones 151a and 151b between the faceplate 130 and the backplate 146 generally outside of the main body 181 of the backplate, and frontward relative to the opening 70, the side-by-side coin mechanism 126 may fit within the same opening 70 that typically houses a coin mechanism 26 that receives only a first coin.

Further, the unique arrangement shown in FIGS. 4-11 provides increased working space within the opening 70, while still covering the mechanical attachment members. By providing at least one of the attachment zones 151a-151c between the faceplate 130 and the backplate 146 generally outside of the main body 181, and frontward relative to the opening 70, upper regions 193 of the main body 181 of the backplate 146 (see FIG. 11) are not directly coupled to the faceplate 130. Therefore, attachment members do not protrude forward into the exposed coin slots 134a and 134b of the faceplate 130. Rather, by providing laterally offset attachment zones 151a and 151b within the frontward raised segments 137a and 137b of the faceplate 130, attachment members are not visible to a user within the first and second coin slots 134a and 134b, and working space may be maximized.

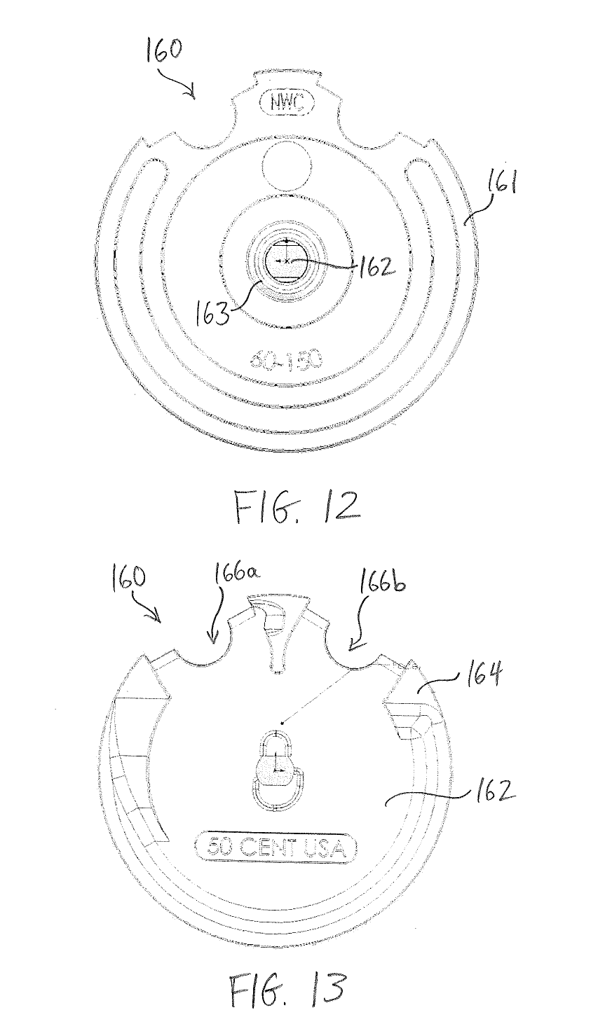

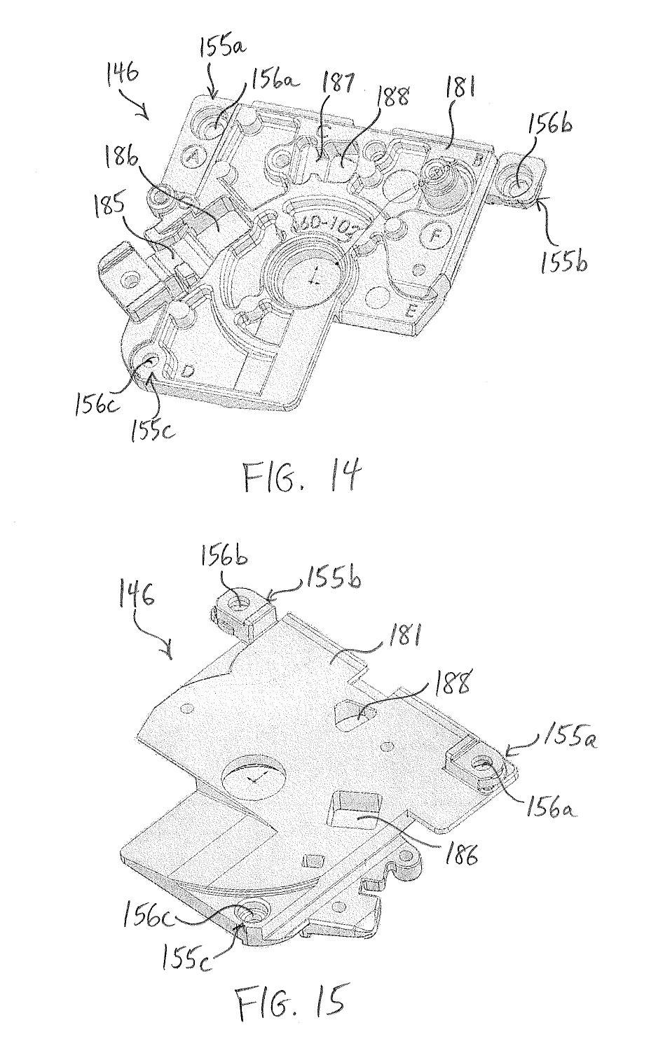

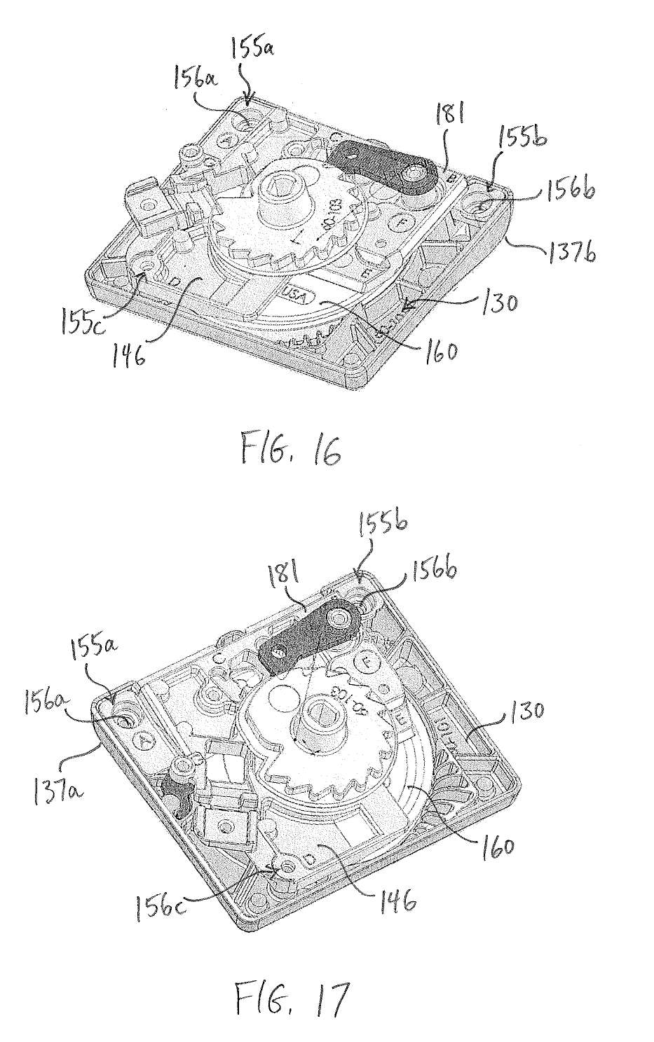

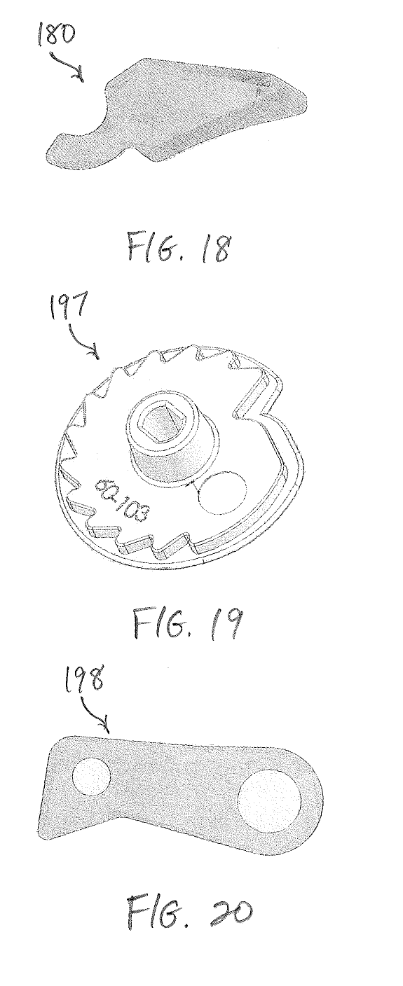

FIGS. 12-20 show different views of various components of the coin mechanism 126 described in FIGS. 4-11. FIGS. 19-20 respectively illustrate a ratchet 197 and a return pawl 198.

It should be noted that while the exemplary embodiments herein depict reference to the M60® and the Triple Play® bulk vending machines, it will be appreciated that the principles herein may be applied to other vending machines.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

I claim:

1. A bulk vending machine having a coin receiving mechanism, wherein the vending machine comprises an opening for receiving at least a portion of the coin receiving mechanism, the coin receiving mechanism comprising:
a) a faceplate having at least one coin slot formed therein;
b) a coin wheel; and
c) a backplate dimensioned to cover at least a portion of the coin wheel and the faceplate,
d) wherein at least one attachment zone for coupling the backplate to the faceplate is positioned at least partially laterally outside of said opening formed in the vending machine.

2. The bulk vending machine of claim 1 wherein the coin wheel is received in a recess formed in a rear surface of the faceplate.

3. The bulk vending machine of claim 1 wherein said opening is less than 2.8 inches wide.

4. The bulk vending machine of claim 1 wherein the backplate comprises a main body having a width dimensioned to fit within said opening, the backplate further comprising:
at least one attachment segment extending laterally away from the main body and positioned frontward relative to the main body, such that the attachment segment is positioned frontward relative to said opening during use.

5. The bulk vending machine of claim 4 wherein the attachment segment of the backplate comprises a bore formed therein for receiving a mechanical attachment member.

6. The bulk vending machine of claim 4 wherein the faceplate comprises at least one frontward raised portion for housing the attachment segment and a mechanical attachment member.

7. The bulk vending machine of claim 1 wherein the coin wheel further comprises a raised hub formed on a front surface of the coin wheel, wherein the raised hub is sized to mate with a central recess formed in a rear surface of the faceplate.

8. The bulk vending machine of claim 1 further comprising a spring loaded pawl movably attached to the backplate and configured to prevent movement of the coin wheel when other than a coin of a predetermined dimension is positioned within a pocket of the coin wheel.

9. The bulk vending machine of claim 1 wherein the coin wheel comprises a rear surface having first and second coin pockets disposed in a side-by-side manner.

10. The bulk vending machine of claim 9 wherein the first and second coin pockets are each sized fit United States quarter dollars.

11. A coin receiving mechanism for a vending machine, comprising:
a) a faceplate having at least one coin slot formed therein;
b) a coin wheel; and
c) a backplate dimensioned to cover at least a portion of the coin wheel and the faceplate,
d) wherein the backplate comprises at least one attachment segment for coupling the backplate to the frontplate, wherein the at least one attachment segment extends laterally away from a main body of the backplate and is positioned frontward relative to the main body.

12. The coin receiving mechanism of claim 11 secured in a vending machine wherein the main body of the backplate has a width dimensioned to fit within an opening formed in the vending machine for receiving the coin receiving mechanism.

13. The coin receiving mechanism of claim 11 secured in a vending machine wherein the attachment segment is positioned at least partially laterally outside of an opening formed in the vending machine for receiving the coin receiving mechanism.

14. A method for retrofitting a bulk vending machine, the method comprising:
a) removing a first coin receiving mechanism having one coin slot from engagement with an opening formed in the vending machine; and
b) installing a second coin receiving mechanism having two coin slots disposed in a side-by-side manner into engagement with said opening of the vending machine.

15. The method of claim 14 wherein the second coin receiving mechanism comprises a faceplate, a backplate, and a coin wheel disposed therebetween, the method further comprising:
providing at least one attachment zone for coupling the backplate to the faceplate at least partially laterally outside of said opening of the vending machine.

16. The method of claim 15 further comprising:
providing at least one frontward raised portion in the faceplate that is dimensioned to accommodate a mechanical attachment member that couples the backplate to the faceplate.

17. The method of claim 15 wherein the backplate comprises a main body having a width that is dimensioned to fit within said opening formed in the vending machine, the method further comprising:
providing at least one attachment segment formed in the backplate and extending laterally away from the main body,
wherein the attachment segment of the backplate is positioned frontward relative to the main body of the backplate, and wherein the attachment segment is positioned frontward relative to said opening of the vending machine.

18. The method of claim 15 wherein the coin wheel comprises first and second coin pockets disposed in a side-by-side manner.

19. The method of claim 18 wherein the first and second coin pockets are each sized fit United States quarter dollars.

20. The method of claim 15 wherein the coin wheel further comprises a front surface adapted to be received in an indentation formed in a rear surface of a faceplate, the front surface having a raised hub that is sized to mate with a central recess formed in the rear surface of the faceplate.
